(19) United States
(12) Patent Application Publication
(10) Pub. No.: US 2025/0158375 A1
(43) Pub. Date: May 15, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP); Kyosuke Okuda, Kariya (JP)

(21) Appl. No.: 18/942,342

(22) Filed: Nov. 8, 2024

(30) Foreign Application Priority Data
Nov. 13, 2023 (JP) 2023-192661

(51) Int. Cl. H02G 11/00; B60J 7/043; B60R 16/02; H01B 11/02; H02G 3/04

(52) U.S. Cl. CPC H02G 11/00; B60R 16/0215; H02G 3/0462; B60J 7/043; H01B 11/02

(57) ABSTRACT

A routing structure includes: a first protector fixed to a body of a vehicle; a second protector fixed to a glass slider that moves along a vehicular front-back direction with respect to an opening provided to a roof of the body; a braided tube having a first end and a second end; a twisted pair cable inserted through the braided tube; and a steel strip inserted through the braided tube, the steel strip keeping the braided tube having a bend that bends in the vehicular front-back direction between the first end and the second end, in which the steel strip is a plate-shaped member and has a support surface on which the twisted pair cable is supported, and the twisted pair cable includes two wires that are mutually insulated and are independent of each other, the two wires being integrally routed in a spirally crossing manner.

### CROSS-REFERENCE TO RELATED APPLICATION(S)

The present application claims priority to and incorporates by reference the entire contents of Japanese Patent Application No. 2023-192661 filed in Japan on Nov. 13, 2023.

### BACKGROUND OF THE INVENTION

### 1. Field of the Invention

The present invention relates to a routing structure.

### 2. Description of the Related Art

Conventionally, provided is a routing structure between a fixed structure and a movable structure. Japanese Patent Application Laid-open No. 2010-195189 discloses a routing structure for a wire harness, the routing structure including: a wire having an end electrically connected to an electrical-machinery component on a fixed structure and having the other end electrically connected to an electrical-machinery component on a movable structure; a band-shaped flat spring made of metal, the band-shaped flat spring having an end fixed to the fixed structure and having the other end fixed to the movable-side structure; and a binder that binds the wire to the band-shaped flat spring.

Such a routing structure has room for further improvement in terms of inhibition of a deterioration in the durability of a wire. For example, regarding a configuration in which a wire and a plate-shaped steel strip are inserted through a braided tube, in a case where the wire is stuck in a gap between the braided tube and the steel strip, the wire is likely to be damaged.

### SUMMARY OF THE INVENTION

An object of the present invention is to provide a routing structure enabling inhibition of a deterioration in the durability of a wire.

In order to achieve the above mentioned object, a routing structure according to one aspect of the present invention includes a first protector fixed to a body of a vehicle; a second protector fixed to a glass slider that moves along a vehicular front-back direction with respect to an opening provided to a roof of the body; a braided tube having a first end held by the first protector and a second end held by the second protector; a twisted pair cable inserted through the braided tube; and a steel strip inserted through the braided tube, the steel strip keeping the braided tube having a bend that bends in the vehicular front-back direction between the first end and the second end, wherein the steel strip is a plate-shaped member and has a support surface on which the twisted pair cable is supported, and the twisted pair cable includes two wires that are mutually insulated and are independent of each other, the two wires being integrally routed in a spirally crossing manner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a sectional view of the routing structure according to the embodiment;

FIG. 4 is a plan view of the routing structure according to the embodiment; and

FIG. 5 is a side view of the routing structure according to the embodiment.

### DETAILED DESCRIPTION OF THE PREFERRED EMBODIMENTS

A routing structure according to an embodiment of the present invention will be described below in detail with reference to the drawings. Note that the invention is not limited to the embodiment. The constituent elements in the following embodiment include constituent elements conceivable easily by those skilled in the art and substantially the same constituent elements.

### Embodiment

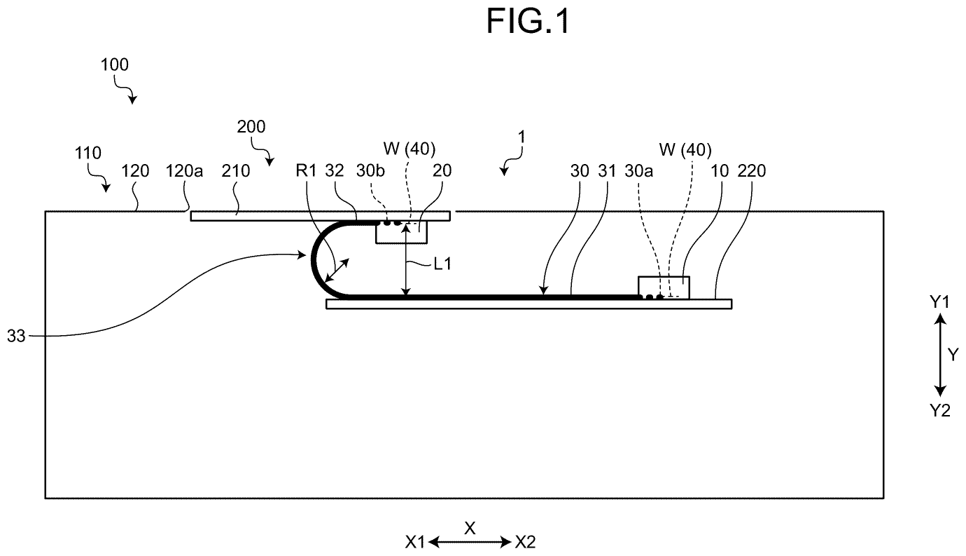

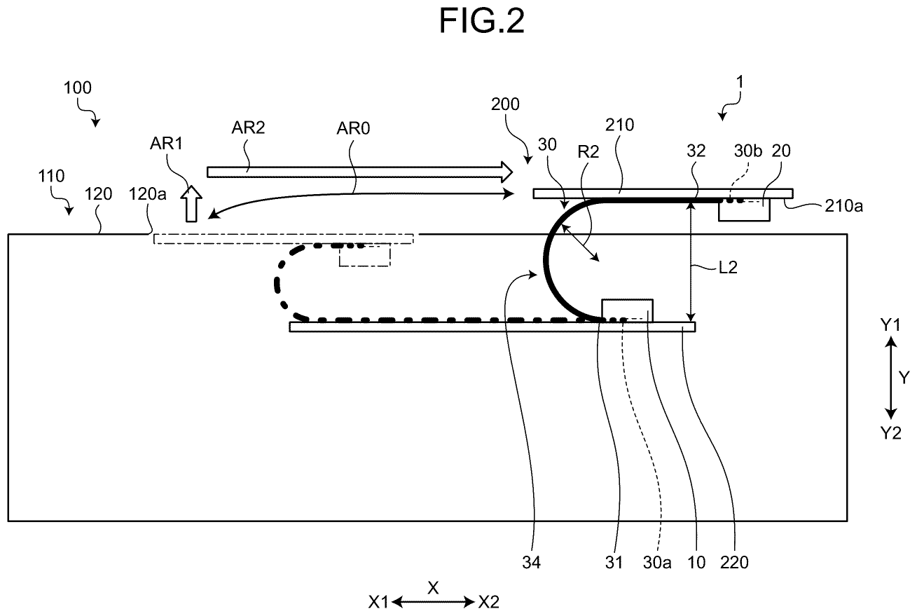

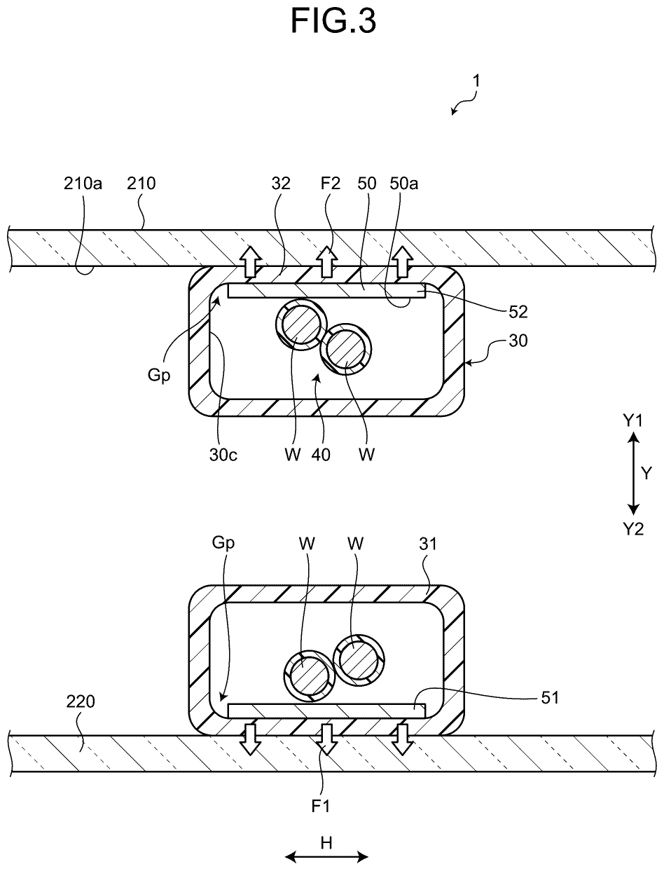

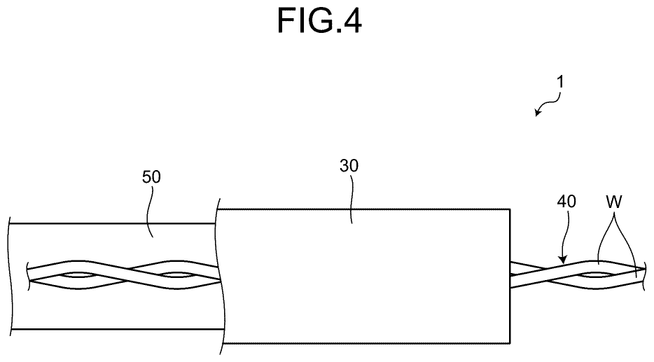

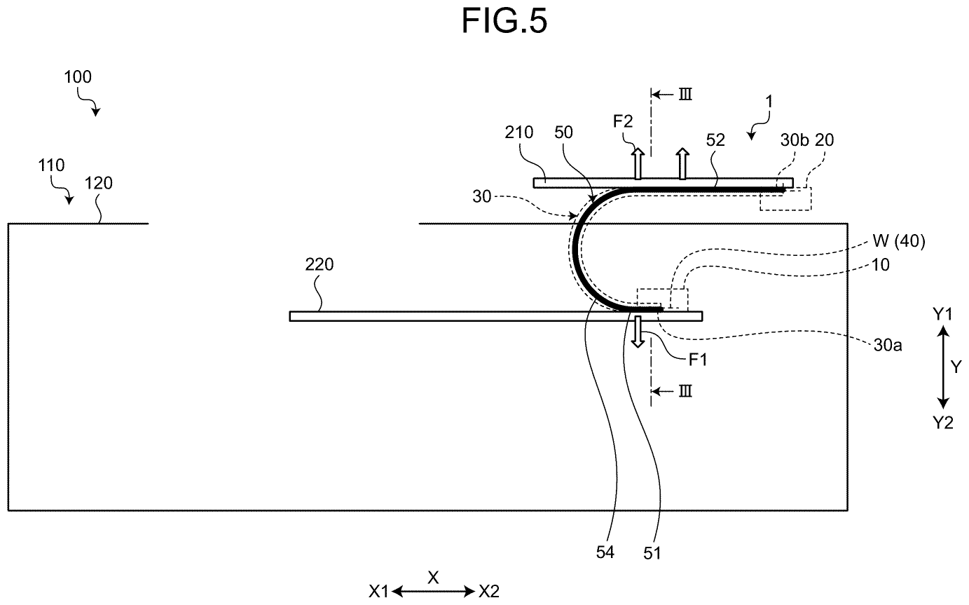

An embodiment will be described with reference to FIGS. 1 to 5. The present embodiment relates to a routing structure. FIGS. 1 and 2 are side views of a routing structure according to an embodiment. FIG. 3 is a sectional view of the routing structure according to the embodiment. FIG. 4 is a plan view of the routing structure according to the embodiment. FIG. 5 is a side view of the routing structure according to the embodiment. FIG. 3 is a sectional view taken along line III-III of FIG. 5.

As illustrated in FIG. 1, a routing structure 1 in an embodiment is applied to a sunroof 200 of a vehicle 100. The vehicle 100 is, for example, an automobile on which a power source, such as a motor or an engine, is mounted. The vehicle 100 includes a body 110. The body 110 includes a roof 120 that covers the interior. The roof 120 includes an opening 120a that is open upward.

The vehicle 100 includes the sunroof 200 that covers or exposes the opening 120a. The sunroof 200 includes a glass slider 210, a rail 220, and the routing structure 1. The glass slider 210 serves as a member that slides along a vehicular front-back direction X with respect to the opening 120a. The glass slider 210 in the present embodiment serves as a plate-shaped member that occludes the opening 120a or exposes the opening 120a. The glass slider 210 may be made of optically transmissive glass.

The sunroof 200 includes a mechanism such as a linkage that moves the glass slider 210 along a predetermined path and a drive source such as a motor that operates the above mechanism. The sunroof 200 moves the glass slider 210 between a fully-closed position for occlusion of the opening 120a and a fully-open position for exposure of the opening 120a. FIG. 1 illustrates the glass slider 210 at the fully-closed position. FIG. 2 illustrates the glass slider 210 at the fully-open position.

The rail 220 is fixed to the body 110. The rail 220 extends in the vehicular front-back direction X. The rail 220 supports the mechanism that moves the glass slider 210 and guides the mechanism in the vehicular front-back direction X. The rail 220 further supports a braided tube 30 such that the braided tube 30 has a first extension 31.

The sunroof 200 in the present embodiment moves the glass slider 210 along a path AR0 illustrated in FIG. 2. Movement of the glass slider 210 along the path AR0 includes movement along the vehicular front-back direction X and movement along a vehicular up-down direction Y. For movement of the glass slider 210 from the fully-closed position to the fully-open position, as indicated by an arrow AR1 in FIG. 2, the glass slider 210 moves to an upper side Y1 in the vehicular up-down direction Y and moves to a back side X2 in the vehicular front-back direction X.

Reversely, for movement of the glass slider 210 from the fully-open position to the fully-closed position, the glass slider 210 moves to a front side X1 in the vehicular front-back direction X and moves to a lower side Y2 in the vehicular up-down direction Y.

As illustrated in FIGS. 1 to 3, the routing structure 1 includes a first protector 10, a second protector 20, the braided tube 30, a twisted pair cable 40, and a steel strip 50. The braided tube 30 and the twisted pair cable 40 are constituents of a wire harness routed between the body 110 and the glass slider 210.

The first protector 10 serves as a member fixed to the body 110 of the vehicle 100. The first protector 10 serves as a protective member that protects the twisted pair cable 40. For example, the first protector 10 is molded of an insulating synthetic resin. The first protector 10 has a space in which the twisted pair cable 40 is routed and has a holding structure in which the braided tube 30 is held.

The second protector 20 serves as a member fixed to the glass slider 210 of the sunroof 200. The second protector 20 serves as a protective member that protects the twisted pair cable 40. For example, the second protector 20 is molded of an insulating synthetic resin. The second protector 20 has a space in which the twisted pair cable 40 is routed and has a holding structure in which the braided tube 30 is held.

The braided tube 30 is a tubular member that is elastically deformable. The braided tube 30 is, for example, a member formed of braided fibers of a synthetic resin. For example, the braided tube 30 is formed of an insulating synthetic resin.

The braided tube 30 has a first end 30a held by the first protector 10 and a second end 30b held by the second protector 20. The first protector 10 holds the first end 30a such that the braided tube 30 extends in the vehicular front-back direction X along the rail 220 from the first protector 10. The first protector 10 in the present embodiment holds the first end 30a such that the braided tube 30 extends from the first protector 10 to the front side X1.

The second protector 20 holds the second end 30b such that the braided tube 30 extends in the vehicular front-back direction X along the glass slider 210 from the second protector 20. The second protector 20 in the present embodiment holds the second end 30b such that the braided tube 30 extends from the second protector 20 to the front side X1.

The twisted pair cable 40 and the steel strip 50 are inserted through the braided tube 30. As illustrated in FIG. 4, the twisted pair cable 40 in the present embodiment corresponds to a twisted line. The twisted pair cable 40 includes two wires W that are mutually insulated and are independent of each other. The two wires W are stranded in a spirally crossing manner. For example, the wires W each correspond to a sheathed wire as a strand having a sheath. The wires W out of the first end 30a are each connected to a power source or a controller disposed on the body 110. The wires W out of the second end 30b are each connected to a load disposed on the side of location of the glass slider 210. The load disposed on the glass slider 210 may be, for example, an illuminator, a light control film disposed on the glass of the glass slider 210, or any electric load.

As illustrated in FIGS. 1 and 2, the braided tube 30 has a bend 33 or 34 that bends in the vehicular front-back direction X between the first end 30a and the second end 30b. The bend 33 illustrated in FIG. 1 corresponds to a bend formed on the braided tube 30 with the glass slider 210 at the fully-closed position. The bend 33 has a radius R1. The bend 34 illustrated in FIG. 2 corresponds to a bend formed on the braided tube 30 with the glass slider 210 at the fully-open position. The bend 34 has a radius R2. The braided tube 30 having the bend 33 or 34 has a U shape or J shape.

As illustrated in FIG. 1, with the glass slider 210 at the fully-closed position, the distance along the vehicular up-down direction Y of the second end 30b to the first end 30a is a first distance L1. The radius R1 of the bend 33 is half the first distance L1.

As illustrated in FIG. 2, with the glass slider 210 at the fully-open position, the distance along the vehicular up-down direction Y of the second end 30b to the first end 30a is a second distance L2. The radius R2 of the bend 34 is half the second distance L2.

The second end 30b of the braided tube 30 moves together with the glass slider 210. In this case, the braided tube 30 follows movement of the second protector 20 such that the position of formation of the bent shape of the braided tube 30 gradually varies.

The steel strip 50 in the present embodiment has rigidity such that the braided tube 30 can be pressed to the glass slider 210. The steel strip 50 is a plate-shaped member and is elastically deformable. The steel strip 50 is formed of metal such as stainless steel.

As illustrated in FIG. 3, the braided tube 30 in the present embodiment has a rectangular cross section. The exemplified steel strip 50 is flat in shape. The steel strip 50 has a rectangular cross section orthogonal to the axial direction of the steel strip 50. The steel strip 50 extends from an end to the other end in a width direction H of the inner space of the braided tube 30.

The steel strip 50 faces the twisted pair cable 40 in the vehicular up-down direction Y. In other words, the steel strip 50 has a width such that a plurality of twisted pair cables 40 can be supported. The steel strip 50 has a support surface 50a on which the twisted pair cable 40 is supported. The support surface 50a is one of two main surfaces that the steel strip 50 has. The support surface 50a in the present embodiment is plane.

The steel strip 50 in FIG. 3 is disposed outside the twisted pair cable 40. Therefore, at the bend 33 or 34, the steel strip 50 is located radially outside the twisted pair cable 40. Due to such an arrangement, the radius of curvature of the twisted pair cable 40 is smaller than the radius of curvature of the steel strip 50 at the bend 33 or 34. As illustrated in FIG. 3, the steel strip 50 is in contact with the braided tube 30 and gives pressing forces F1 and F2 to the braided tube 30 through its contact surface.

As illustrated in FIG. 5, the braided tube 30, the twisted pair cable 40, and the steel strip 50 are routed in a bent state, such as in a U shape or J shape. That is, while having a bend 54, the steel strip 50 extends from the first protector 10 to the second protector 20.

The bent steel strip 50 having the bend 54 gives the pressing forces F1 and F2 to the braided tube 30. The pressing force F1 acts as a force in the vehicular up-down direction Y and presses the braided tube 30 to the rail 220. The pressing force F2 acts as a force in the vehicular up-down direction Y and presses the braided tube 30 to the glass slider 210. The pressing forces F1 and F2 are the restoring force acting on the bent steel strip 50.

Due to the pressing force F1, the braided tube 30 has the first extension 31. Due to the pressing force F2, the braided tube 30 has a second extension 32. For example, as illustrated in FIG. 2, the second extension 32 corresponds to a portion extending along an interior-side surface 210a of the glass slider 210. The interior-side surface 210a corresponds to a surface facing the lower side Y2. In a case where the interior-side surface 210a is plane, the second extension 32 is linear. In a case where the interior-side surface 210a is bent in shape, the second extension 32 has a shape bent along the interior-side surface 210a.

The steel strip 50 in the present embodiment presses the braided tube 30 to the glass slider 210 in both a case where the glass slider 210 is located at the fully-closed position and a case where the glass slider 210 is located at the fully-open position. In other words, the steel strip 50 has rigidity such that the braided tube 30 can be pressed to the glass slider 210 in contact with the glass slider 210 all the time. Therefore, the routing structure 1 in the present embodiment enables stabilization of the shape of the braided tube 30. For example, against external force such as vibration in traveling, the steel strip 50 can keep the braided tube 30 in contact with the glass slider 210.

As described below, the routing structure 1 in the present embodiment enables inhibition of a deterioration in the durability of the twisted pair cable 40. As illustrated in FIG. 4, the twisted pair cable 40 corresponds to a twisted line and includes two wires W stranded in a spirally crossing manner. Thus, the wires W are inhibited from dropping into a gap between the steel strip 50 and the braided tube 30. As illustrated in FIG. 3, a gap Gp is present between the steel strip 50 and the braided tube 30. The gap Gp corresponds to the gap between a side surface of the steel strip 50 and an inner surface 30c of the braided tube 30. Entry of a wire W into the gap Gp is likely to cause the corresponding edge of the steel strip 50 to damage the sheath of the wire W.

Against this, the twisted pair cable 40 in the present embodiment corresponds to a twisted line having spiral crossings. Thus, each wire W is less likely to enter the gap Gp than each wire W routed singly is. Even if each wire W enters the gap Gp, the length of its entered portion is small. Furthermore, even in a case where one wire W enters the gap Gp, the other wire W pulls the one wire W, so that the one wire W can come out easily from the gap Gp. Therefore, the routing structure 1 in the present embodiment keeps the wires W insusceptible to damage, leading to inhibition of a deterioration in the durability of the twisted pair cable 40.

The twisted pair cable 40 having spiral crossings enables accommodation of the excessive lengths of the wires W and relaxation of a pulling force acting on the twisted pair cable 40. In a case where the braided tube 30 and the twisted pair cable 40 each have a bend due to movement of the glass slider 210, a pulling force or compressive force may act on the twisted pair cable 40. The twisted pair cable 40 as a twisted line can absorb such a force.

As described above, the routing structure 1 in the present embodiment includes the first protector 10, the second protector 20, the braided tube 30, the twisted pair cable 40, and the steel strip 50. The first protector 10 is fixed to the body 110 of the vehicle 100. The second protector 20 is fixed to the glass slider 210 that moves along the vehicular front-back direction X with respect to the opening 120a provided to the roof 120 of the body 110. The braided tube 30 has the first end 30a held by the first protector 10 and the second end 30b held by the second protector 20.

The twisted pair cable 40 and the steel strip 50 are inserted through the braided tube 30. The steel strip 50 is a member that causes the braided tube 30 to have the bend 33 or 34 that bends in the vehicular front-back direction X between the first end 30a and the second end 30b. The steel strip 50 is a plate-shaped member and has the support surface 50a on which the twisted pair cable 40 is supported. The twisted pair cable 40 includes two wires W that are mutually insulated and are independent of each other. The two wires W are integrally routed in a spirally crossing manner.

The two wires W integrally routed in a spirally crossing manner are less likely to enter the gap Gp than each wire W routed independently is. Therefore, the routing structure 1 in the present embodiment enables inhibition of a deterioration in the durability of the twisted pair cable 40 due to damage to the wires W. The twisted pair cable 40 including the two wires W spirally crossing enables a reduction of the force acting on the wires W having bends.

In the routing structure 1 in the present embodiment, the radius of curvature of the twisted pair cable 40 is smaller than the radius of curvature of the steel strip 50 at the bend 33 or 34. The support surface 50a of the steel strip 50 corresponds to an inner surface at the bend 33 or 34 and supports the twisted pair cable 40 from outside. Such an arrangement enables proper protection of the wires W. Note that the steel strip 50 may be disposed inside the twisted pair cable 40.

The details disclosed in the above embodiment can be carried out in appropriate combination.

In a routing structure according to the present embodiment, a twisted pair cable includes two wires that are mutually insulated and are independent of each other. The two wires are integrally routed in a spirally crossing manner. The routing structure according to the present embodiment effects inhibition of a deterioration in the durability of the wires with the wires inhibited from being stuck in a gap between a braided tube and a steel strip.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first protector fixed to a body of a vehicle;
a second protector fixed to a glass slider that moves along a vehicular front-back direction with respect to an opening provided to a roof of the body;
a braided tube having a first end held by the first protector and a second end held by the second protector;
a twisted pair cable inserted through the braided tube; and
a steel strip inserted through the braided tube, the steel strip keeping the braided tube having a bend that bends in the vehicular front-back direction between the first end and the second end, wherein
the steel strip is a plate-shaped member and has a support surface on which the twisted pair cable is supported, and
the twisted pair cable includes two wires that are mutually insulated and are independent of each other, the two wires being integrally routed in a spirally crossing manner.

2. The routing structure according to claim 1, wherein
a radius of curvature of the twisted pair cable is smaller than a radius of curvature of the steel strip at the bend.
